(19) United States
(12) Patent Application Publication
(10) Pub. No.: US 2014/0346815 A1
(43) Pub. Date: Nov. 27, 2014

(54) Magnetic Field Shield for Electromagnetic Fields and Vehicle Having an Integrated Magnetic Field Shield

(71) Applicants: ThyssenKrupp Steel Europe AG, Duisburg (DE); ThyssenKrupp Electrical Steel GmbH, Gelsenkirchen (DE)

(72) Inventors: Andreas Keutz, Dusseldorf (DE); Dorothee Dorner, Dusseldorf (DE); Andreas Jansen, Dinslaken (DE); Florian Herget, Bochum (DE); Andreas Breidenbach, Bruhl (DE); Lothar Patberg, Moers (DE)

(21) Appl. No.: 14/365,888

(22) PCT Filed: Dec. 5, 2012
(86) PCT No.: PCT/EP2012/074505

§ 371 Date: Jun. 16, 2014

(30) Foreign Application Priority Data
Dec. 21, 2011 (DE) 10 2011 056 807.7

(51) Int. Cl. B62D 25/20; H01F 27/36; B32B 7/12; B60L 11/18; B32B 15/18; B32B 15/04

(52) U.S. Cl. CPC B62D 25/20; B32B 15/18; B32B 15/04; B32B 7/12; B60L 11/18; H01F 27/362; B32B 2250/03; B32B 2307/212; B32B 2605/00
USPC 296/193.07; 428/457; 296/1.01

(57) ABSTRACT

The invention relates to a magnetic field shield for electromagnetic fields, preferably in the frequency range of 50 Hz to 200 kHz, essentially comprising a composite sheet formed from at least three layers arranged one above the other, wherein at least one of the layers is made of electrical steel sheet or electrical steel strip. In order to provide at low cost such a magnetic field shield that has low weight and good shielding effect, it is proposed that at least one of the layers is made of sheet steel and at least one of the layers is made of plastic and/or elastomer, wherein the at least one layer made of plastic and/or elastomer integrally bonds together the at least one layer made of electrical steel sheet/electrical steel strip and the at least one layer made of sheet steel.

The invention relates to a magnetic field shield for electromagnetic fields, preferably in the frequency range of 50 Hz to 200 kHz, in particular of 60 kHz to 200 kHz, essentially comprising a composite sheet formed from at least three layers arranged one above the other, at least one of the layers being made of electrical steel sheet or electrical steel strip. In addition, the invention relates to a vehicle, in particular an electrically driven motor vehicle, having such a magnetic field shield.

EP 1 241 926 A2 discloses a magnetic field shield for electromagnetic fields in the frequency range of 10 Hz to 1 kHz, which is constructed from at least two layers. In this case, one layer is made of electrical steel sheet and a second layer of non-ferrous metal, preferably aluminium.

In addition, DE 10 2009 039 600 B3 discloses a magnetic field shield for electromagnetic fields in the frequency range of 0 Hz to 50 kHz that is constructed from at least two layers, at least one layer being made of a non grain-orientated electrical steel sheet and at least one layer of aluminium, each of these layers being constructed from plates welded together in a butt-joint and/or overlapping arrangement.

In particular for magnetic field shields for vehicles, there is a need for low-cost magnetic field shields that are as lightweight as possible. Although using aluminium offers the opportunity of reducing the weight of a magnetic field shield of the type mentioned in the introduction, aluminium is a relatively expensive material. In addition, aluminium sheet requires special joining tools for making welded joints, which tools are relatively expensive and are sometimes difficult to use.

The object of the present invention is to provide a magnetic field shield of the type mentioned in the introduction, which has a good shielding effect while also combining excellent structural-design and/or functional properties.

A magnetic field shield having the features of claim 1 is proposed in order to achieve this object.

The subclaims contain preferred and advantageous embodiments of the magnetic field shield according to the invention.

The magnetic field shield according to the invention comprises (instead of an aluminium layer or an aluminium sheet) at least one layer made of sheet steel and additionally at least one layer made of plastic and/or elastomer, the at least one layer made of plastic and/or elastomer integrally bonding together the at least one layer made of electrical steel sheet or electrical steel strip and the at least one layer made of sheet steel.

Within the scope of the present invention, sheet steels are all grades of steel that have properties that do not equate to grades of electrical steel sheet or electrical steel band.

The magnetic field shield according to the invention is not, for instance, an additional attachment to the vehicle. Instead, the magnetic field shield according to the invention, in particular as a bodywork part or chassis part, performs additional functions or roles at the same time such as, for example, sealing the vehicle interior from the environment and/or compliance with the crash or rigidity requirements made of the bodywork or fulfilling chassis functions. By virtue of this integration of functions, it is possible to dispense with an additional shielding wall for example, or to design an additional shielding wall for shielding against electromagnetic fields to be of considerably smaller dimensions and/or lighter. Either case results in a weight reduction and also a cost reduction. An additional feature of the solution according to the invention is that it minimizes the amount of installation space required. Compliance with the structural-design and/or strength requirements is largely achieved by the use of at least one sheet-steel sheet.

Particular advantages over known solutions are achieved using the magnetic field shield according to the invention for electromagnetic fields in the frequency range of 50 Hz to 200 kHz, in particular of 60 kHz to 200 kHz.

The at least one layer made of plastic and/or elastomer, which bonds the metal sheets of the magnetic field shield according to the invention, can additionally perform an acoustic and/or thermally insulating function. This is because this layer can be used to improve both the sound insulation (in particular soundproofing) and the thermal insulation on the vehicle concerned. The layer made of plastic and/or elastomer is preferably thicker than the at least one layer made of electrical steel sheet and/or the at least one layer made of sheet steel.

The composite sheet is preferably embodied as a bodywork part or chassis part.

The above-mentioned advantages of the magnetic field shield according to the invention are achieved in particular when the bodywork part, according to a preferred embodiment, defines a floor panel of an electrically driven motor vehicle equipped with a rechargeable battery.

A further preferred embodiment of the invention is characterised in that the magnetic field shield embodied as a floor panel has a trough-shaped or tunnel-shaped structure, in which is arranged a coil for inductive charging of the battery. By virtue of this geometric embodiment of the magnetic field shield and the arrangement of the coil in the trough-shaped or tunnel-shaped structure, the shielding effect of the magnetic field shield can be improved without additional parts.

According to a further advantageous embodiment of the invention, a guard formed from flaps, a collar or bellows is fitted to the floor panel, which guard encloses the coil and is provided with a drive so that it can be moved from a retracted or raised position into an extended or lowered position and vice versa. An area below the coil can be blocked by this movable guard so that animals, for instance a cat, do not have access to the blocked-off area below the coil. This movable guard is preferably likewise designed as a magnetic field shield.

A further advantageous embodiment of the invention is characterised in that a drive is fitted to the floor panel, which drive can be used to move the coil used for charging the battery from a raised position into a lowered position and vice versa. In the lowered position, the coil acts at the same time as a barrier to animals. In addition, the distance between floor panel and coil in the lowered position of the coil is increased, or in other words the distance between the vehicle-mounted coil and a coil associated therewith and integrated in the road surface is reduced, whereby the exposure to alternating electromagnetic fields during inductive charging of the battery can be reduced.

According to a further advantageous embodiment, the magnetic field shield implemented as a bodywork part can be embodied in particular also as a longitudinal or transverse member. This is because longitudinal or transverse members of a vehicle bodywork can often be used to accommodate electronic components, and therefore the electronic components mounted there are then shielded from electromagnetic interference fields or the electromagnetic interference fields between the electronic components are at least reduced.

In addition, the above-mentioned advantages of the magnetic field shield according to the invention are achieved in particular also for embodiments in which the bodywork part defines a wall and/or a floor of a housing for accommodating a rechargeable battery. During charging of the battery and during power output, fluctuating electromagnetic fields occur in the area around the battery, which can interfere with adjacent sensitive electronic components. The magnetic field shield according to the invention can prevent or at least significantly reduce malfunctions of the adjacent electronic components caused by electromagnetic fields.

The magnetic field shield according to the invention is preferably arranged such that the at least one electrical steel sheet faces the electromagnetic radiation source.

In order to comply with high crash and rigidity requirements, a further advantageous embodiment of the magnetic field shield according to the invention provides that the electrical steel sheet is arranged as a core layer between two layers made of sheet steel, the electrical steel sheet being integrally bonded on both sides to the layers made of sheet steel by layers made of plastic and/or elastomer. In addition, the acoustic properties of the magnetic field shield can be improved by this embodiment.

In order for the magnetic field shield to achieve a particularly long useful life, according to a further embodiment the sheet-steel sheet is made of stainless steel.

According to a further embodiment, a long useful life can also be achieved by providing an anti-corrosion layer on at least one side of the composite sheet.

In order that the magnetic field shield complies with high crash and rigidity requirements although it has the lowest possible weight, according to a further embodiment the sheet-steel sheet is made of austenitic steel or a higher-strength steel having a tensile strength of at least 350 MPa, preferably at least 480 MPa, particularly preferably at least 650 MPa.

In order to improve component rigidity for the low component weight, a further preferred embodiment of the magnetic field shield according to the invention provides that as a bodywork part or chassis part it has a three-dimensional structure produced by forming. In particular, the magnetic field shield according to the invention can have as a bodywork part a trough-shaped or tunnel-shaped structure.

The invention is described in greater detail below with reference to a drawing showing a plurality of exemplary embodiments, in which:

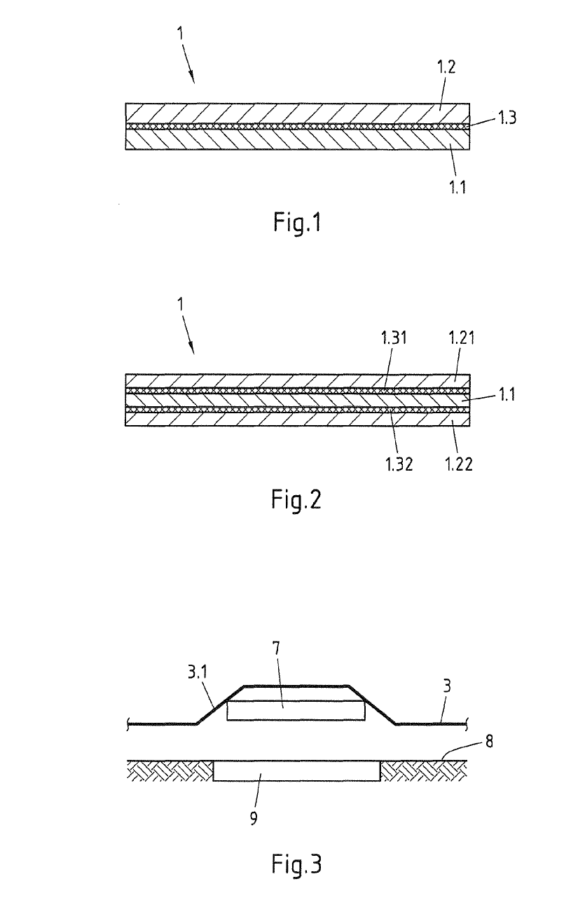

FIG. 1 shows a sectional view of a segment of a three-layer magnetic field shield;

FIG. 2 shows a sectional view of a segment of a five-layer magnetic field shield;

FIG. 3 shows a sectional view of a floor panel of an electric vehicle;

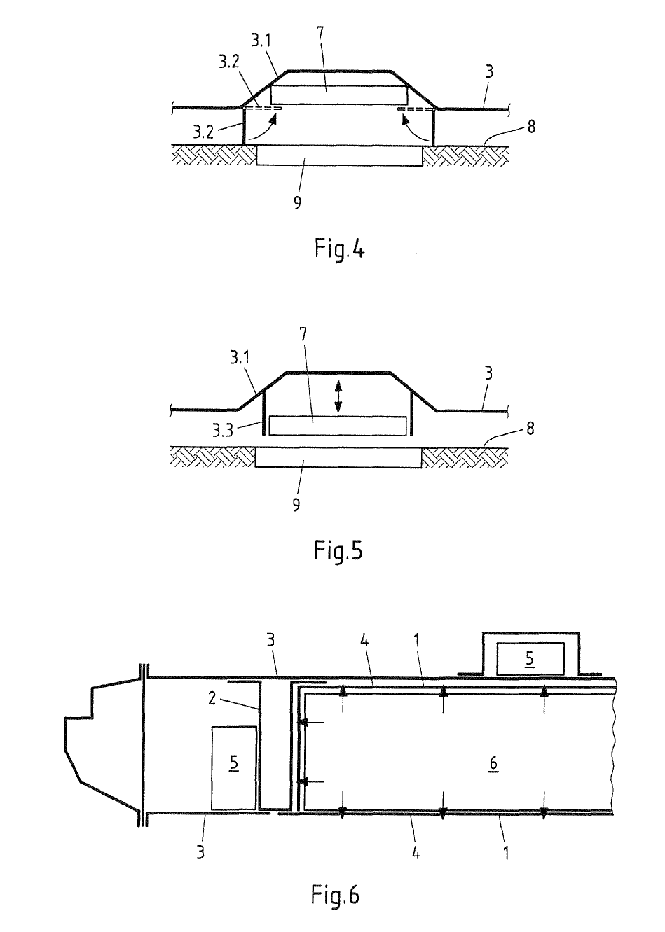

FIG. 4 shows a sectional view of a floor panel of an electric vehicle according to a further exemplary embodiment;

FIG. 5 shows a sectional view of a floor panel of an electric vehicle according to a further exemplary embodiment; and

FIG. 6 shows a sectional view of a floor construction of an electric vehicle comprising a battery housing.

FIG. 1 shows a segment of a three-layer composite sheet (sandwich sheet) 1, which is suitable as a magnetic field shield for electromagnetic fields, in particular in the frequency range of 50 Hz to 200 kHz, and which by cutting to size and/or forming is processed further into a bodywork part or chassis part of a vehicle, in particular of an electric vehicle.

The reference sign 1.1 denotes a layer made of electric steel sheet, which may be a grain-orientated or non grain-orientated electric steel sheet. The shielding of electromagnetic fields is mainly afforded by the layer 1.1, in other words by the electric steel sheet.

In addition, the sandwich sheet 1 according to FIG. 1 comprises a layer 1.2 made of sheet steel and a layer 1.3 made of plastic and/or elastomer. Compliance with the structural-design and/or strength requirements is largely or mostly achieved by the layer 1.2 made of sheet steel. The layer 1.3 made of plastic and/or elastomer is used to bond the metallic layers 1.1, 1.2. It can also be referred to as a bonding layer. Furthermore, the layer 1.3 can improve the acoustic properties of the magnetic field shield implemented as a bodywork part or chassis part. The sandwich sheet 1 according to the invention hence complies with all the requirements (shielding, construction). Although not shown here, the layer 1.3 can be thicker than at least one of the metallic layers 1.1, 1.2.

FIG. 2 shows a second exemplary embodiment of a composite sheet (sandwich sheet) 1 according to the invention for making a bodywork part or chassis part having an integrated magnetic field shield. The sandwich sheet 1 comprises a core layer 1.1 made of electrical steel sheet. The core layer 1.1 is integrally bonded on both sides to layers 1.21, 1.22 made of sheet steel by layers 1.31, 1.32 made of plastic and/or elastomer. The connecting layers (bonding layers) 1.31, 1.32 can improve the acoustic properties of the sandwich sheet 1. They can also be thicker (not shown here) than at least one of the metallic layers 1.21, 1.22.

The sheet-steel sheet 1.2 or 1.21, 1.22 used in the sandwich sheets 1 shown in FIGS. 1 and 2 respectively is, for example, a sheet made of austenitic steel, stainless steel and/or high-strength steel, in particular dual-phase steel. The tensile strength of the sheet steel used for the layer(s) 1.2 or 1.21, 1.22 amounts to at least 350 MPa, preferably at least 480 MPa, particularly preferably at least 650 MPa.

FIGS. 3 to 5 contain sketches of a plurality of exemplary embodiments of a floor 3 of an electric vehicle. In each case, a tunnel-shaped or trough-shaped recess 3.1 is formed in the floor 3. A coil 7 for inductive charging of the battery of the electric vehicle is arranged in the recess 3.1. 8 denotes a road surface or parking surface in which is integrated at least one coil 9 for inductive charging of electric vehicles. The parking surface 8 containing the integrated charging coil 9 can be located in a garage or car park for example.

In the exemplary embodiments sketched in FIGS. 3 to 5, the floor panel 3 is in each case made from a sandwich sheet 1 according to FIG. 1 or FIG. 2. When using a sandwich sheet 1 according to FIG. 1, the electric steel sheet 1.2 preferably faces the coil 7. Using the electric steel sheet on the side facing away from the coil 7 is also included in the scope of the invention. In addition, the sandwich sheet 1 according to FIG. 1 is preferably provided at least on that side of the sandwich sheet facing the coil 7 with an anti-corrosion layer, for instance with a zinc layer or zinc-nickel layer.

In the exemplary embodiment shown in FIG. 4, a guard formed from flaps 3.2 is fitted to the floor panel 3, which guard encloses the coil 7 and is provided with a drive (not shown) so that it can be moved from a retracted or raised position into an extended or lowered position and vice versa. While the electric vehicle is moving, the flaps 3.2 are retracted upwards. During the inductive charging of the battery of the electric vehicle on the parking surface 8 on the other hand, the flaps 3.2 are in the extended-downwards position. Both positions of the flaps 3.2 are indicated in FIG. 4.

In the exemplary embodiment according to FIG. 5, a drive (not shown) is fitted to the floor panel 3, which drive can be used to move the coil 7 from a raised position into a lowered position and vice versa. The reference signs 3.3 are assigned to a guide for the coil 7 that can be raised and lowered, and to a power line leading from the coil 7 to the battery 6 (see figure. 6).

FIG. 6 shows a floor construction of an electric vehicle. The floor of the electric vehicle is constructed from longitudinal and transverse members 2 and at least one floor panel 3. A battery housing (battery chamber) 4 is accommodated or integrated in the floor.

Electronic components 5 are fitted in and/or on the floor. Depending on the power consumption or power output of the battery 6, fluctuating electromagnetic fields occur, which can interfere with the electronic components. The interference fields are shown schematically by small arrows arranged on the battery housing 4. Electromagnetic interference fields between the electronic components 5 are reduced by materials in the structural components of the floor construction or of the battery housing 4, which materials have good shielding properties. For this purpose, the floor panel 3, the transverse and/or longitudinal members 2 and/or the battery housing 4 are made from sandwich sheet 1 according to FIG. 1 and/or FIG. 2. The layer 1.2 (or 1.21 and/or 1.22) of the sandwich sheet 1 is here preferably made of high-strength steel having a tensile strength of at least 480 MPa, particularly preferably at least 650 MPa. In addition to good shielding effect, this can achieve good crash protection in particular for the battery 6.

The realization of the present invention is not limited to the exemplary embodiments shown in the drawing. In fact numerous variants are possible which, even in a different design, make use of the invention given in the enclosed claims. In particular, the magnetic field shield according to the invention can also comprise two or more layers 1.1 made of electric steel sheet. In addition, the scope of the present invention includes combining some or all of the design features of the exemplary embodiments sketched in FIGS. 3 to 6.

1. A magnetic field shield for electromagnetic fields comprising: a composite sheet (1) formed from at least three layers (1.1, 1.2, 1.3; 1.1, 1.21, 1.22, 1.31, 1.32) arranged one above the other, wherein at least one of the layers is made of electrical steel sheet or electrical steel strip, wherein at least one of the layers is made of sheet steel and at least one of the layers is made of plastic, elastomer, or a combination of plastic and elastomer wherein the at least one layer made of plastic, elastomer, or a combination of plastic and elastomer integrally bonds together the at least one layer made of electrical steel sheet or electrical steel strip and the at least one layer made of sheet steel.

2. The magnetic field shield according to claim 1, wherein the composite sheet is implemented as a bodywork part or chassis part of a vehicle.

3. The magnetic field shield according to claim 1, wherein the bodywork part defines a floor panel of an electrically driven motor vehicle equipped with a rechargeable battery.

4. The magnetic field shield according to claim 3, wherein the floor panel has a trough-shaped or tunnel-shaped structure in which is arranged a coil for inductive charging of the battery.

5. The magnetic field shield according to claim 4, further comprising a guard formed from flaps, a collar or bellows is fitted to the floor panel, which guard encloses the coil and is provided with a drive so that it can be moved from a retracted or raised position into an extended or lowered position and vice versa.

6. The magnetic field shield according to claim 4, wherein a drive is fitted to the floor panel, which drive can be used to move the coil from a raised position into a lowered position and vice versa.

7. The magnetic field shield according to claim 2, wherein the bodywork part is embodied as a longitudinal or transverse member.

8. The magnetic field shield according to claim 2, wherein the bodywork part defines a wall and/or a floor of a housing for accommodating a rechargeable battery.

9. The magnetic field shield according to claim 1, wherein the electrical steel sheet faces an electromagnetic radiation source.

10. The magnetic field shield according to claim 1, wherein the electrical steel sheet is arranged as a core layer between two layers made of sheet steel, wherein the electrical steel sheet is integrally bonded on both sides to the layers made of sheet steel by layers made of plastic, elastomer, or a combination of plastic and elastomer.

11. The magnetic field shield according to claim 1, wherein the sheet-steel sheet is made of stainless steel.

12. The magnetic field shield according to claim 1, wherein the sheet-steel sheet is made of austenitic steel or a higher-strength steel having a tensile strength of at least 350 MPa.

13. The magnetic field shield according to claim 1, wherein the composite sheet as a bodywork part or chassis part has a three-dimensional structure produced by forming.

14. The magnetic field shield according to claim 1, wherein the composite sheet as a bodywork part or chassis part has a trough-shaped or tunnel-shaped structure.

15. The magnetic field shield according to claim 1, wherein an anti-corrosion layer is provided on at least one side of the composite sheet.

16. A vehicle, in particular electrically driven motor vehicle, having an integrated magnetic field shield according to claim 1.

17. The magnetic shield according to claim 1, wherein the electromagnetic field is within a frequency range of 50 Hz to 200 kHz.
